(19) United States
(12) Patent Application Publication
(10) Pub. No.: US 2018/0265712 A1
(43) Pub. Date: Sep. 20, 2018

(54) BINDER COMPOSITION FOR HEAT-SEALABLE FILM COATINGS

(71) Applicant: BASF SE, Ludwigshafen am Rhein (DE)

(72) Inventors: Christof van Sluijs, AN Leeuwarden (NL); Gerald Metselaar, AJ Groningen (NL); Hilly Maandag, EX Kampen (NL); Arjan Termaten, GC Assen (NL)

(73) Assignee: BASF SE, Ludwigshafen am Rhein (DE)

(21) Appl. No.: 15/762,633

(22) PCT Filed: Sep. 9, 2016
(86) PCT No.: PCT/EP2016/071247

§ 371 Date: Mar. 23, 2018

(30) Foreign Application Priority Data
Sep. 23, 2015 (EP) 15186498.0

(51) Int. Cl. C09D 5/02; C09D 133/10; C09D 133/12; C09D 125/14; C09D 7/63; C08J 7/04; B05D 1/40; B05D 3/02

(52) U.S. Cl. CPC C09D 5/022; C09D 133/10; C09D 133/12; C09D 125/14; C09D 7/63; C08J 2425/08; B05D 1/40; B05D 3/0272; C08J 2323/12; C08J 2433/10; C08J 2433/12; C08J 7/047

(57) ABSTRACT

Provided herein is a binder composition for heat-sealable film coatings including from 10 to 65 weight-% of a polymeric binder. The polymeric binder includes, as monomers, keto- or aldehyde containing monomers, monoolefinically unsaturated monomers, and copolymerizable surfactants. The monoolefinically unsaturated monomers contain less than 0.4 weight-% of the monomers with acidic functional groups or amides of acidic functional groups with respect to the total weight of the monomers. The polymeric binder furthermore contains from 2.5 to 100 mole-% dihydrazide crosslinker with respect to the keto- or aldehyde-containing monomers, optionally from 0 to 3.0 weight-% non-reactive surfactant, from 35 to 90 weight-% water, optionally from 0 to 20 weight-% other additives, and optionally from 0 to 20 weight-% humectant. Further provided herein is a process for preparing an aqueous sealing coating that includes applying a binder composition on a heat-sealable film including corona treated polyolefins.

### FIELD OF THE INVENTION

The invention relates to a binder composition comprising polymeric binder, dihydrazide crosslinker, and water. Optionally humectant, non-reactive surfactant and/or other additives may be comprised in said binder composition. Furthermore, the invention relates to an aqueous sealing coating and a process for preparing aqueous sealing coating comprising applying a binder composition. In particular, the invention relates to the use of a binder composition for the preparation of heat-sealable film coatings. Specifically, the invention relates to heat-sealable film.

### BACKGROUND OF THE INVENTION

Polyolefin films, such as polyethylene (LDPE, HDPE), cast polypropylene (CPP) and bi-axially oriented polypropylene (BOPP) films, are widely used in packaging structures as print and/or seal (closure) medium. To increase the packaging machine output, these films are often coated with a waterborne acrylic polymer that reduces the melt/sealing temperature.

For example, commercially available acrylic coated BOPP films are based on a corona treated coextruded-BOPP film, coated with a polyethyleneimine (PEI) or polyurethane (PUD) primer and a formulated acrylic topcoat. The application of a primer is necessary to maintain the adhesion of the acrylic coating to the BOPP film during the sealing operation. Using this setup stress concentrations at the interface due to shrinkage/expansion must be overcome.

Eliminating the use of primers in packaging applications is advantageous due to a variety of reasons for different industry target groups. Film producers experience cost reduction, while formulators benefit from the extension of product range and backwards integrated packaging converters obtain the opportunity of in-line coating/printing.

Currently, only a small number of heatseal lacquers with direct adhesion to corona treated polyolefin films, such as BOPP films are commercially available. Lacquers based on a blend of an ethylene-acrylic-acid (EAA) copolymer and a polyurethane dispersion (PUD) are for example offered by the company Michelman.

In general often the costs for direct adhesion heatseal lacquers are higher than for the current solutions using a primer.

U.S. Pat. No. 4,529,772 describes contact adhesives obtained from synthetic raw materials which are used for the production of self-adhesive articles. Materials which serve as bases for the production of such self-adhesive articles include paper, and films of metal, polyethylene, polypropylene, polyethylene terephthalate or PVC. The contact adhesive dispersions described in U.S. Pat. No. 4,529,772 aqueous dispersions of copolymers and water soluble alipatic dihydrazine compounds. The copolymers of U.S. Pat. No. 4,529,772 contain 0.5-5 weight-% of monoolefinically unsaturated carboxylic acids and/or their amides which are unsubstituted or substituted at the nitrogen atoms by alkyl and/or alkylol radicals, and/or hydroxyalkyl (meth)acrylates. No heat-seal applications are mentioned in U.S. Pat. No. 4,529,772.

EP 0 148 386 A1 relates to layers of adhesives which are applied onto polyolefin surfaces from aqueous dispersion. Adhesion of layers is achieved by applying a dicarboxylic acid dihydrazide of 2 to 10 carbon atoms and an aqueous dispersion of an adhesive polymer onto the polyolefin surfaces which have been pretreated by corona discharge. Dicarboxylic acid dihydrazide is used as a primer for adhesion promotion but not in combination with carbonyl-containing monomers. No heat-seal applications are mentioned in EP 0 148 386 A1.

US 2007/0251423 A1 describes aqueous coating composition comprising vinyl polymers comprising 0.1-20 weight-% of vinyl monomer containing acid functional groups and 0-0.49 weight-% of vinyl monomer containing a carbonyl functional group and also 0.01-10 weight-% of at least one polyhydrazine compound. No heat-seal applications are mentioned in US 2007/0251423 A1.

The production process of acrylic coated polyolefin films, such as BOPP films normally starts with a corona treatment of the film surface. In general this leads to the formation of polar groups such as alcohol, ketone, aldehyde and carboxyl groups at the polyolefin surface. These polar groups usually improve wetting and adhesion properties.

Currently acrylic binders are typically made of monomers such as methylacrylate, methyl-methacrylate, or methacrylic acid. Typical physical properties are: an acid number of about 30 (mg KOH/g), a glass transition temperature (Tg) of about 55° C., a minimum film-forming temperature (MFT) of about 20° C. and a mass-average molecular mass Mw of about 40.000 Dalton. Such acrylic binders usually do not give proper adhesion to polyolefin films, in particular to BOPP films, after the sealing process if no additional primer is applied. Even the addition of other adhesion promotors, such polyurethanes, polyethyleneimines, polyesters or tackifiers, to the formulation or the introduction of adhesion promoting monomers, such hydroxyethyl (meth)acrylate, N,N-dimethylaminoethyl methacrylate, hydroxypropylcarbamate acrylate, ureido methacrylate or triethoxysilane often gives only insufficient adhesion.

The objective at hand was to develop a novel binder which shows improved direct adhesion to corona related polyolefin films such as BOPP.

Surprisingly it was found, that using binder composition described in detail below comprising a polymeric binder with keto- or aldehyde containing monomers as well as copolymerizable surfactants, dihydrazide crosslinker and optionally humectant provides improved direct adhesion to corona related polyolefin films such as BOPP and good shelf-life properties.

### SUMMARY OF THE INVENTION

In accordance with the present invention, there are provided binder compositions for heat-sealable film coatings comprising
(a.) from 10 to 65 weight-% of a polymeric binder,
   said polymeric binder containing as monomers
      (i.) keto- or aldehyde containing monomers,
      (ii.) monoolefinically unsaturated monomers,
      (iii.) copolymerizable surfactants,
wherein said monoolefinically unsaturated monomers (ii.) contain less than 0.4 weight.-% of monomers with acidic functional groups or amides of acidic functional groups with respect to the total weight of monomers (i.)-(iii.),
(b.) from 2.5 to 100 mole-% dihydrazide crosslinker with respect to keto- or aldehyde-containing monomers (i.),
(c.) from 0 to 3.0 weight-% non-reactive surfactant,
(d.) from 35 to 90 weight-% water,
(e.) from 0 to 20 weight-% other additives, and
(f.) from 0 to 20 weight-% humectant
wherein the total amount of components (a.)-(f.) is equal to 100 weight-%.

In another aspect of the invention a process is provided for preparing an aqueous sealing coating comprising applying a binder composition according to the invention on a heat-sealable film comprising corona treated polyolefins.

Upon application of compositions according to the invention it is believed that the components of the composition have different roles. It is supposed that the use of dihydrazide crosslinker (b.) results in direct adhesion to the corona treated surface of the polyolefin film, while keto- or aldehyde containing monomers (i.) of the polymeric binder (a.) serve as crosslinkers to enhance the contact between the polymeric binder and the surface. The use of keto- or aldehyde containing monomers (i.) for the polymeric binder (a.) furthermore provides enhanced film toughness. The presence of copolymerizable surfactants (iii.) within the polymeric binder (a.) seems to avoid migration of adhesion disturbing ingredients to the binder/polyolefin film interface. Inclusion of humectants in the composition is believed to retain water for longer times and probably results in a reduced crosslinking reaction speed.

In this manner, aqueous sealing coatings are provided by utilizing a process according to the invention.

Addition of other additives to the composition according to the invention is used to fine-tune the properties of these compositions and/or the properties of aqueous sealing coatings for specific applications.

### DETAILED DESCRIPTION OF THE INVENTION

In one aspect the present invention provides binder compositions for heat-sealable film coatings comprising
(a.) from 10 to 65 weight-%, preferably from 20 to 50 weight-%, more preferably from 30 to 50 weight-%, most preferably from 40 to 50 weight-% of a polymeric binder said polymeric binder containing as monomers
   (i.) keto- or aldehyde containing monomers, preferably acrylic or styrenic keto- or aldehyde containing monomers, more preferably acetoacetoxyethyl methacrylate, diacetone acrylamide (DAAM) or acrolein, most preferably diacetone acrylamide (DAAM),
   (ii.) monoolefinically unsaturated monomers,
   (iii.) copolymerizable surfactants,
wherein said monoolefinically unsaturated monomers (ii.) contain less than 0.4 weight-% of monomers with acidic functional groups or amides of acidic functional groups with respect to the total weight of monomers (i)-(iii),
(b.) from 2.5 to 100 mole-%, preferably from 5 to 75 mole-%, more preferably from 10 to 50 mole-%, most preferably from 20 to 40 mole-% dihydrazide crosslinker with respect to keto- or aldehyde-containing monomers (ii.),
(c.) from 0 to 3.0 weight-% non-reactive surfactant, preferably from 0 to 2.0 weight-%, more preferably from 0 to 1.0 weight-%, most preferably from 0 to 0.5 weight-%,
(d.) from 35 to 90 weight-%, preferably from 40 to 85 weight-%, more preferably from 40 to 75 weight-%, even more preferably from 45 to 75 weight-%, most preferably from 55 to 75 weight-% water,
(e.) from 0 to 20 weight-%, preferably from 4 to 16 weight-%, more preferably from 5 to 15 weight-%, most preferably from 5 to 10 weight-% other additives, and
(f.) from 0 to 20 weight-%, preferably from 1 to 15 weight-%, more preferably from 1 to 10 weight-%, most preferably from 1 to 7.5 weight-% humectant
   wherein the total amount of components (a.)-(f.) is equal to 100 weight-%.

The preparation of a binder composition according to the invention is well known to those skilled in the art. In general, said binder compositions are prepared by mixing the components (a.)-(f.).

The skilled in the art will readily appreciate that the mixture of components (a.)-(f.) may be varied as necessary to tailor the binder composition to the particular application at hand.

In a preferred embodiment of the composition according to the invention the monoolefinically unsaturated monomers (ii.) contain less than 0.2 weight-% of monomers with acidic functional groups or amides of acidic functional groups. Monomers with acidic functional groups or amides of acidic functional groups are for example acrylic acid, acrylic acid amides, methacrylic acid, itaconic acid, maleic acid or fumaric acid. In a more preferred embodiment of the composition according to the invention the monoolefinically unsaturated monomers (ii.) do not contain acidic functional groups or amides of acidic functional groups.

In a further preferred embodiment of the composition according to the invention the polymeric binder (a.) contains as monomers
(i.) from 1 to 15 weight-%, preferably from 1 to 8 weight-%, more preferably from 3 to 8 weight-%, most preferably from 3 to 6 weight-% keto- or aldehyde-containing monomer.
(ii.) from 70 to 98 weight-%, preferably from 75 to 95 weight-%, more preferably from 80 to 95 weight-%, most preferably from 80 to 90 weight-% monoolefinically unsaturated monomers.
(iii.) from 0.5 to 15 weight-%, preferably from 1 to 7 weight-%, more preferably from 1.5 to 5 weight-%, most preferably from 2 to 4 weight-% copolymerizable surfactant,
wherein the total amount of components (i.), (ii.) and (iii.) is equal to 100 weight-%.

The preparation of a polymeric binder (a.) comprising monomers (i.)-(iii.) is well known to those skilled in the art. The skilled in the art will readily appreciate that the mixture of monomers (i.)(iii.) may be varied as necessary to tailor the polymeric binder (a.) to the particular application at hand.

The preparation of water-borne polymers is well known to those skilled in the art. For example, the preparation of polymeric binders (a.) is described in Emulsion Polymerization by Gilbert, R. G., Academic Press, N.Y., 1995, pp 1-23 and in Polymer Dispersions and Their Industrial Applications by Urban, D. and Takamura, K., Wiley-VCH Verlag GmbH, Germany, 2002, pp 15-40. Monomers that can be used as keto- or aldehyde containing monomers (i.) for the polymeric binder (a.) are different from monomers that can be used as monoolefinically unsaturated monomers (ii.). Monoolefinically unsaturated monomers from class (ii.), contrary to those from class (i.), do not contain keto- or aldehyde functional groups that can react with a dihydrazide crosslinker.

Monomers that can be used as keto- or aldehyde containing monomers (i.) for the polymeric binder (a.) are for example carbonyl-containing monomers such as diacetonmethacrylamide, formylstyrene, vinyl alkyl ketone of 4 to 7 carbon atoms, a (meth)acryloxyalkylpropanal of the formula (I), diacetone acrylamide, acetoacetoxyethyl methacrylate, acetoacetoxyethyl acrylate, allyl acetoacetate, vinyl acetoacetate, acrolein, diacetone acrylate, acetonyl acrylate, diacetone methacrylate, 2-hydroxypropyl acrylate acetylacetate, butanediol-1,4-acrylate acetylacetate, vinyl methyl ketone, vinyl ethyl ketone, vinyl butyl ketone, a hybrid thereof, or a blend thereof.

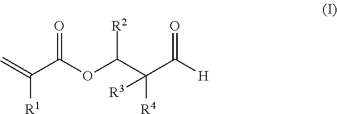

wherein R¹ is hydrogen or methyl, R² is hydrogen or alkyl of 1 to 3 carbon atoms, R³ is alkyl of 1 to 3 carbon atoms and R⁴ is alkyl of 1 to 4 carbon atoms. Preferred monomers (i.) are diacetone acrylamide, acetoacetoxyethyl methacrylate or acrolein. A particularly preferred monomer (i.) is diacetone acrylamide.

Monomers that can be used as monoolefinically unsaturated monomers (ii.) for the polymeric binder (a.) are selected from alkyl acrylates, alkyl methacrylates, hydroxy-, epoxy- or anhydride-containing monoolefinically unsaturated monomers, vinyl esters, vinyl chloride, styrenes, acrylic acid, methacrylic acid, itaconic acid, acrylamide or methacrylamide.

Specific monomers (ii.) are acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, methylol acrylamide, glycidyl acrylate, glycidyl methacrylate, styrene, methyl styrene, alpha-methyl styrene, ethyl styrene, isopropyl styrene, tertiary-butyl styrene, acyclic conjugated dienes, vinyl esters and vinyl chloride. Preferred monomers (ii.) are acrylic acid, methacrylic acid, 2-hydroxyethyl methacrylate, methyl methacrylate, butyl acrylate, butyl methacrylate, 2-ethylhexyl acrylate, ethyl acrylate, methyl acrylate and styrene. More preferred monomers (ii) are methacrylic acid, 2-hydroxyethyl methacrylate, methyl methacrylate, and butyl acrylate.

Monomers that can be used as copolymerizable surfactants (iii.) for the polymeric binder (a.) can belong to different classes of surfactants, such as anionic, non-ionic or cationic copolymerizable surfactants. Anionic copolymerizable surfactants for example can have sulfonate, sulfate, carboxylate, phosphate or phosphonate head-groups.

Copolymerizable surfactants (iii.) are also referred to as surface active monomers or surfmers. Examples of surfmers are maleic surfmers, maleimide-containing surfmers, (meth)acrylic surfmers, styrenic surfmers, crotonate surfmers, fumarate surfmers, alkenyl surfmers, surfmers with vinyl polymerizable group or surfmers with allyl polymerizable group.

The location of the (co)polymerizable part of the copolymerizable surfactants (iii.) can vary. The copolymerizable part can be for example in the terminal part of the hydrophilic or hydrophobic part of the copolymerizable surfactant or it can form a conjunctive link between the hydrophilic or hydrophobic parts.

A number of reactive nonionic and anionic copolymerizable surfactants (iii.) are commercially available, including sodium allyloxy hydroxypropyl sulfonates, allyloxy methylalkoxyethyl poyoxyethylene sulfates, alkenyl-functional nonionic surfmers, allylmethoxy triethylene glycol ether, sodium methallyl sulfonates, sulfopropyl acrylate, vinyl sulfonate, vinyl phosphate, monosodium ethylsulfonate monododecyl maleate, sorbitol acrylate, sorbitol methacrylate, perfluoroheptoxy poly(propyloxy) methacrylate, phenoxyl poly(ethyleneoxy acrylate, phenoxyl poly(ethyleneoxy) methacrylate, nonyl phenoxy poly(ethyleneoxy) crotanate, nonylphenoxy poly(ethyleneoxy) fumarate, nonyl phenoxy poly(ethyleneoxy) acrylate, nonylphenoxy poly(ethyleneoxy) methacrylate, mono dodecyl maleate, and allylsulfosuccinate derivatives.

Preferred copolymerizable surfactants (iii.) are allyloxy methylalkoxyethyl poyoxyethylene sulfates.

Polymeric binders (a.) of the binder composition according to the invention in general have a weight average molecular weight Mw of at least 20.000 g/mol, preferably from 25.000 to 500.000 g/mol, and more preferably from 30.000 to 300.000 g/mol.

Polymeric binders (a.) of the binder composition according to the invention in general have a number average molecular weight Mn of at least 5.000 g/mol, preferably from 5.000 to 20.000 g/mol, and more preferably from 7.000 to 20.000 g/mol.

Mw, Mn and polydispersity are routinely measured using Gel Permeation Chromatography (GPC).

Polymeric binders (a.) of the binder composition according to the invention in general have a polydispersity index PDI (Mw/Mn) of from 2 to 40, preferably from 2 to 30, and more preferably from 2 to 25.

Polymeric binders (a.) of the binder composition according to the invention in general have a glass transition temperature Tg of from −5 to 75° C., preferably from 0 to 65° C., and more preferably from 5 to 55° C.

Theoretical Tg's are estimated using the Fox equation. Experimental Tg's are determined using Differential Scanning calorimetry (DSC).

A wide range of dihydrazide crosslinkers (b.) are suitable for use in the binder composition. Typical examples for dihydrazide crosslinkers (b.) are water-soluble dihydrazide compounds. Suitable dihydrazide compounds are those of aliphatic dicarboxylic acids of 2 to 10, in particular 4 to 6, carbon atoms, e.g. oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide.

Suitable di- or oligohydrazide crosslinkers (b.) furthermore include but are not limited to dicarboxylic acid dihydrazides examples of which include pivalic acid, pimelic acid, suberic acid, azelaic acid, undecanedioic acid, dodecanedioic acid, tridecanedioic acid, tetradecanedioic acid, pentadecanedioic acid, hexadecanedioic acid and 2-methyltetradecanedioic dihydrazide. Other carboxylic acid hydrazides include methyl-, ethyl-, propyl-, butyl-, hexyl-, heptyl-, octyl-, 2-ethylhexyl-, nonyl-, decyl-, undecyl- and dodecyl-malonic dihydrazide, methyl-, ethyl-, propyl-, butyl-, hexyl-, heptyl- and octyl-succinic dihydrazide, cyclohexanedicarboxylic and 2-ethyl-3-propylsuccinic and -glutaric cyclohexylmethylmalonic dihydrazide, terephthalic, phenylsuccinic, cinnamylmalonic and benzylmalonic dihydrazide, pentane-1,3,5-tricarboxylic trihydrazide, hex-4-ene-1,2,6-tricarboxylic trihydrazide, 3-cyanopentane-1,3,5-tricarboxylic trihydrazide and dicyanofumaric dihydrazide, as well as di- and oligohydrazides of dimeric and oligomeric unsaturated fatty acids.

Hydrazides of aromatic polycarboxylic acids, e.g. the dihydrazides of phthalic acid, terephthalic acid and isophthalic acid and the dihydrazides, trihydrazides and tetrahydrazide of pyromellitic acid may also be used.

Examples of other suitable hydrazide compounds are polyhydrazides of polyacrylic acids which contain 2 or more hydrazide groups, in most cases 20 to 100 hydrazide groups, per molecule, trihydrazides, e.g. nitrilotriacetic acid trihydrazide, and tetrahydrazides, e.g. ethylenediaminetetraacetic acid tetrahydrazide.

Further suitable compounds are hydrazides of carbonic acid, e.g. carbonic acid dihydrazides and compounds of the general formula H₂N—NHC(═O)—(NH—NH—C(═O)—)ₓNH—NH₂, where x is from 1 to 5, preferably 1 to 3.

Other suitable hydrazides are aliphatic and cycloaliphatic bis-semicarbazides of the general formula H₂N—NH—C(═O)—NH—R⁴—HN═C(O)—NH—NH₂, where —R⁴— is a straight or branched aliphatic group of 2 to 14 carbon atoms or a carbocyclic group of 6 to 14 carbon atoms, e.g. o-, m- or pphenylene, toluylene, cyclohexylidene or methylcyclohexylidene. Also bis-thiocarbazides can be used.

Mixtures of different dihydrazides can of course be used as dihydrazide crosslinkers (b.).

Particularly preferred dihydrazide crosslinker (b.) is adipic acid dihydrazide.

A wide range of non-reactive surfactants (c.) are suitable for use in the binder composition including anionic, cationic, and nonionic. Typically, anionic surfactants include alkyl sulfonates, alkylaryl sulfonates, alkyl sulfates, sulfates of hydroxyalkanols, alkyl and alkylaryl disulfonates, sulfonated fatty acids, sulfates and sulfonates of polyethoxylated alkanols and alkylphenols as well as esters of sulfosuccinic acid.

In another preferred embodiment of the binder composition according to the invention non-reactive surfactants (c.) are selected from polyethoxylated linear primary fatty alcohols, polyethoxylated branched primary fatty alcohols, polyethoxylated linear secondary fatty alcohols or polyethoxylated branched secondary fatty alcohols.

In general other additives (e.) of the binder composition are defoamers, coalescent and wetting agents, waxes, polymeric fillers, mineral fillers, or mixtures of these additives, preferably defoamers and waxes.

Examples of defoamers are silicone defoamers (organically modified polysiloxanes), polymeric defoamers, mineral oil defoamers.

Examples of waxes that are generally used as slip agents or anti-blocking agents are polyethylene wax, paraffin wax, microcrystalline wax, beeswax, carnauba wax, montan wax, candelilla wax, synthetic wax or mixtures of the above mentioned waxes.

Examples of polymeric and mineral fillers that are generally used as slip agents or anti-blocking agents are polymethylmethacrylate particles, silicone particles, silica, colloidal silica, fumed silica particles, silicone gum, talc, finely-divided clay or mixtures of the above mentioned fillers.

Examples of coalescent and wetting agents are hexyl- or benzyl-ether of ethylene glycol, hexylether of diethylene glycol, butyl alcohol, hexyl alcohol, octyl alcohol, diacetone alcohol, citric acid esters, non-ionic surfactant, anionic surfactant or mixtures of the above mentioned agents. A wide range of humectants (f.) are suitable for use in the binder composition including synthetic humectants and humectants of biological origin. Typical examples of humectants are propylene glycol, polypropylenglycol (PPG), 1,2,6 hexanetriol, butylene glycol, dipropylene glycol, hexylene glycol, glycerin, triethylene glycol, erythritol, capryl glycol, phytantriol, hexanediol or -triol, glyceryl triacetate, urea, alpha hydroxy acids such as lactic acid, panthenol, sodium PCA (sodium-2-pyrrolidone-5-carboxylate), hyaluronic acid, inositol, glycogen sugars and modified sugars, sorbitol, polyglyceryl sorbitol, polysaccharide, polydextrose, glucose, fructose, xylitol, maltitol, collagen, silicone copolyols or mixtures of the above mentioned humectants.

In a preferred embodiment of the binder composition according to the invention humectants (f.) are selected from propylene glycol, polypropylenglycol (PPG), modified sugars, sorbitol, polyglyceryl sorbitol, polysaccharide, polydextrose, glucose, fructose, xylitol, maltitol. More preferably humectants (f.) are modified sugars and sorbitol.

In a second aspect the present invention provides a process for preparing an aqueous sealing coating comprising applying a binder composition according to the invention on a heat-sealable film comprising corona treated polyolefins.

The preparation of an aqueous sealing coating according to the invention is well known to those skilled in the art.

In a preferred embodiment of the process according to the invention, the heat-sealable film consists of corona treated polyolefins. Preferably, said polyolefins are polyethylene and polypropylene, and most preferably bi-axially oriented polypropylene (BOPP).

In a third aspect the present invention provides an aqueous sealing coating obtained by a process according to the second aspect of the invention.

In a fourth aspect the present invention provides the use of a binder composition according to the invention for the preparation of heat-sealable film coatings.

In a fifth aspect the present invention provides a heat-sealable film in contact with an aqueous sealing coating prepared by a process according to the second aspect of the invention.

### EXAMPLES

### Abbreviations

DW=Demineralized water
DAAM=Diacetone acrylamide
MA=Methyl acrylate
EA=Ethyl acrylate
BA=n-Butyl acrylate

### Sty=Styrene

SR10=Reasoap SR10 (Adeka)—Ammonium salt of allyloxy methylalkoxyethyl polyoxyethylene (10EO) sulfate
SR1025=Reasoap SR1025 (Adeka)—25 weigt-% aqueous solution of Reasoap SR10 Softanol 120=polyethoxylated (EO=12) secondary branched C₁₂-C₁₄ alcohol
MMA=Methyl methacrylate
IOMPA=Isooctyl mercaptopropionate
ADH=Adipic acid dihydrazide
APS=Ammonium persulfate

### Example I

### Preparation of Polymeric Binder:

To a 2 L 4-necked flask equipped with a mechanical stirrer, nitrogen inlet and thermocouple were charged 386.0 g DW, 2.0 g SR1025 (copolymerizable surfactant (iii.)), 2.5 g Softanol 120 (cosurfactant=non-reactive surfactant=component (c.)) and 1.0 g NaHCO₃ (pH buffer). The mixture was heated to T=76° C. and a solution of 0.7 g APS in 7.0 g DW was added.

Subsequently, after 5 minutes, a mixture of 4.5 g SR10, 70.0 g EA, 70.0 g MA, 10.0 g DAAM, 30.0 g MMA and 2.3 g IOMPA was added to the reaction mixture over a 75 min addition time using a peristaltic pump. When all was added, the addition tube was flushed with 10.0 g DW.

After 40 min hold time, a mixture of 20.0 g Sty and 0.25 g IOMPA was added over a 10 min period using a peristaltic pump. When all was added, the addition tube was flushed with 10.0 g DW and the reaction mixture was stirred for an additional hour at about T=76° C.

Then, 373.0 g DW was added and the dispersion was cooled to ambient temperature (ca. 25° C.). Aqueous ammonia (25 weight-%, 0.5 g) was added and the resulting emulsion polymer was filtered through a 37.5 μm clothfilter. Some key-characteristics of the obtained product are listed in Table x.

TABLE 1
physical properties of polymeric binder obtained in Example I
Example I

| | |
|---|---|
| Tg (° C.), via Fox equation | 23.0 |
| Non-volatile content (weight-%) | 19.9 |
| pH | 9.0 |
| z-average particle diameter (nm) | 90 |

The thus obtained polymeric binder (emulsion polymer) was subsequently formulated with different amounts of adipic acid dihydrazide (ADH) (Table 2).

TABLE 2
Amount of ADH (mol-% with respect to DAAM) added to different formulations of Example I.

| | Entry | | | | | | | | | |
|---|---|---|---|---|---|---|---|---|---|---|
| | #1 | #2 | #3 | #4 | #5 | #6 | #7 | #8 | #9 | #10 |
| ADH (Mole-% with respect | 0 | 5.0 | 12.5 | 25.0 | 37.5 | 50.0 | 75.0 | 100.0 | 125.0 | 150.0 |
| to DAAM) | | | | | | | | | | |

### Example II

### Preparation of Polymeric Binder:

DW (300.0 g), 5.0 g of Softanol 120 (non-reactive surfactant=component (c.)), 4.0 g SR1025 (copolymerizable surfactant (iii.)) and 1.0 g NaHCO₃ were added to a 4-necked 2 L flask equipped with mechanical stirrer, nitrogen inlet and thermocouple. The mixture was heated to about T=85° C. and a solution of 2.0 g APS in 47.0 g DW was added.

After 3 min hold-time, phase I (see table 3) was added over a 60 min period using a peristaltic pump. When all was added, the addition tube was flushed with 10.0 g DW and the reaction mixture was stirred for an additional 10 min. Next, phase II (table 3) was added over 50 min using a peristaltic pump, again followed by flushing with 10.0 g of DW.

The reaction mixture was stirred for an additional 60 min at about T=85° C. and was then cooled to about T=60° C., upon which 0.5 g aqueous ammonia (25%) and ADH were added (table 3). After 10 min, 50.0 g DW was added, the reaction mixture was allowed to cool to ambient temperature and the resulting polymer dispersion was filtered through a 37.5 μm clothfilter.

TABLE 3
Feed compositions for Example II.

Entry

| | | #1 | #2 | #3 | #4 |
|---|---|---|---|---|---|
| Phase I | DW (g) | 103.0 | 103.0 | 103.0 | 103.0 |
| | DAAM (g) | 20.0 | 5.0 | — | — |
| | SR 1025 (g) | 36.0 | 36.0 | 36.0 | 36.0 |
| | BA (g) | 100.0 | 100.0 | 100.0 | 100.0 |
| | Sty (g) | 100.0 | 100.0 | 100.0 | 100.0 |
| | IOMPA (g) | 2.0 | 2.0 | 2.0 | 2.0 |
| Phase II | BA (g) | 100.0 | 100.0 | 100.0 | 100.0 |
| | MMA (g) | 100.0 | 100.0 | 100.0 | 100.0 |
| | DAAM (g) | — | — | — | 20.0 |

| | | | | |
|---|---|---|---|---|
| ADH (g) | 2.5 | 2.5 | 2.5 | 2.5 |

### Example III

To a 4-necked 2 L flask equipped with mechanical stirrer, nitrogen inlet and thermocouple were added DW (table 4) and 4.0 g SR1025 (copolymerizable surfactant (iii.)). The mixture was heated to T=85° C. and a solution of 1.0 g NaHCO₃ and 2.0 g APS in 47.0 g DW was added. After 3 min hold-time, a pre-emulsion consisting of a solution of DAAM (20.0 g) in DW (103.0 g), SR1025 (36.0 g), BA (100.0 g), Sty (100.0 g) and IOMPA (2.0 g) was added over a 60 min period using a peristaltic pump. When all was added, the addition tube was flushed with 10.0 g DW and the reaction mixture was stirred for an additional 10 min. Subsequently, a mixture of BA (100.0 g) and MMA (100.0 g) was added over a period of 50 min using a peristaltic pump, again followed by flushing the addition tube with 10.0 g DW.

The reaction mixture was stirred for an additional 60 min. at T=85° C. and was then cooled to T=60° C., upon which different base (table 4), ADH (7.5 g) and additional DW (table 4) were added.

TABLE 4
Bases and water charges for synthesis entries #1-#4.

| Entry | | #1 | #2 | #3 | #4 |
|---|---|---|---|---|---|
| Base | NaOH (0.33 | 75.0 | 150.0 | — | — |
| | wt % in H₂O) (g) | | | | |
| | Triethanol- | — | — | 0.5 | — |
| | amine (g) | | | | |
| | Dimethyleth- | — | — | — | 0.5 |
| | anolamine (g) | | | | |

| | | | | |
|---|---|---|---|---|
| DW, reactor charge (g) | 282.5 | 207.5 | 300 | 300 |
| DW, post addition (g) | — | — | 57 | 57 |

### Example IV

### Preparation and Application of an Aqueous Sealing Coating:

The coating dispersions are applied as prepared on fresh corona treated oriented polypropylene MB400 from Jindal by using a wire bar coating technique. The coated film is dried in a laboratory oven for 1 minute at a temperature of about 80° C. The dry coating weight is 1.0+/−0.2 g/m².

### Testing of the Coated Film:

Prior to testing, all samples were stored for 24 hours at about 21° C. and 50% relative humidity. Application data are shown in tables 5 and 6 for binder compositions of examples I and II.

The static and dynamic coefficients of friction (CoF) were determined using equipment from Testing Machines Inc. (200 grs weight sled, test speed 40 cm/min, face to face). The test method is based on ASTM D1894.

Two 15 mm wide strips of the above described coated polypropylene films were sealed face to face at sealing temperatures ranging from 90 till 120° C. (HSG-C lab sealer from Brugger, sealing pressure is 1 bar, dwell time is 0.7 sec). In each case the seal strength was determined using tensile test equipment (Lloyd Instruments) at a speed of 150 mm/min. The maximum tensile force is taken as the seal strength.

The ethanol resistance is tested by means of a so-called drop test. A drop of ethanol is placed on the acrylic coating. After 5 minutes the surface is judged visually.

TABLE 5
Application data of binder composition based on
example I - peel force N/15 mm

| | Entry | | | | | | | | | |
|---|---|---|---|---|---|---|---|---|---|---|
| | #1 | #2 | #3 | #4 | #5 | #6 | #7 | #8 | #9 | #10 |
| SS (90) | 0.2 | 0.2 | 1.0 | 2.7 | 2.8 | 2.0 | 1.5 | 0.3 | 0.2 | 0.2 |
| SS | 0.2 | 0.2 | 1.2 | 2.8 | 2.4 | 1.5 | 1.3 | 0.6 | 0.2 | 0.2 |
| (100) | | | | | | | | | | |
| SS | 0.2 | 0.2 | 1.1 | 2.4 | 2.3 | 1.7 | 1.1 | 0.9 | 0.2 | 0.2 |
| (110) | | | | | | | | | | |
| SS | 0.2 | 0.2 | 1.5 | 3.0 | 2.5 | 1.8 | 1.5 | 1.2 | 0.2 | 0.2 |
| (120) | | | | | | | | | | |

Note:
SS (x) is the seal strength at the indicated sealing temperature x (in N/15 mm).

The results of table 5 show that the adhesion of the coating on corona treated BOPP film is improved by the ADH addition. In case of sample #1 (without ADH) the failure mode is at the coating/BOPP interface, while cohesion failure is observed for the other samples (including ADH).

TABLE 6
Application data of binder composition
based on example II- peel force N/15 mm

| Entry | #1 | #2 | #3 | #4 |
|---|---|---|---|---|
| CoF (s) | 0.19 | 0.25 | 0.38 | 0.36 |
| CoF (d) | 0.12 | 0.10 | 0.12 | 0.14 |
| SS (90) | 3.8 | 0.2 | 0.2 | 3.5 |
| SS (100) | 4.4 | 0.2 | 0.2 | 4.5 |
| SS (110) | 4.7 | 0.2 | 0.2 | 4.3 |
| SS (120) | 4.6 | 0.2 | 0.2 | 4.8 |
| ER (5 min) | transparent | white | white | Transparent |

Note:
SS(x) is the seal strength at the indicated sealing temperature x (in N/15 mm),
CoF (s) is the static coefficient of friction and CoF (d) is the dynamic coefficient of friction. Average data for commercial available films (MB666 Jindal):
CoF (static) = 0.30
CoF (dynamic) = 0.25.
ER (5 min) is the ethanol resistance after 5 minutes treatment of the coated film.

If the coating has a white appearance, the ethanol resistance is poor.

If the coating is transparent, the ethanol resistance is good.

TABLE 7
Application data of binder composition based
on example III- peel force N/15 mm

| Entry | #1 | #2 | #3 | #4 |
|---|---|---|---|---|
| SS (90) | 4.7 | 3.8 | 4.3 | 4.6 |
| SS (100) | 5.0 | 4.7 | 4.3 | 4.8 |
| SS (110) | 4.7 | 4.7 | 5.0 | 5.0 |
| SS (120) | 4.9 | 4.8 | 4.6 | 4.4 |

Note:
SS(x) is the seal strength at the indicated sealing temperature x (in N/15 mm),

### Example V

In the state of the art, the main target of technical development is in general a maximum adhesion of a binder on corona treated surfaces such as BOPP. This target in general is approached by maximizing the amount of ADH.

An object of the invention at hand is maximizing the seal strength of two corona treated BOPP films, coated with an acrylic binder, when heat sealed to each other. In this case both adhesion of a binder on a corona treated BOPP surface as well as the cohesive strength of the binder are important.

The following systems were compared in a lab experiment (table 8):

### Entry a of Table 8:

The acrylic binder #1 (example II) without ADH, coated on the corona treated BOPP surface.

### Entry b of Table 8:

The acrylic binder #1 (example II) without ADH, coated on a corona treated BOPP film which was coated with a polyethyleneimine (PEI) primer first.

### Entry c of Table 8:

The acrylic binder #1 (example II) with ADH, coated on a corona treated BOPP film which was coated with a polyethyleneimine (PEI) primer first.

### Preparation and Application of an Aqueous Sealing Coating:

The coating dispersions are applied as received on fresh corona treated oriented polypropylene MB400 from Jindal by using a wire bar coating technique. The coated film is dried in a laboratory oven for 1 minute at a temperature of about 80° C. The dry coating weight is 1.0+1-0.2 g/m².

In case of an additional primer, a PEI primer solution is coated on the corona treated BOPP film first (drying 1 min. at 80° C., coating weight 0.05 g/m²) prior to the acrylic coating.

### Testing of the Coated Film:

Prior to testing, all samples were stored for 24 hrs at about 21° C. and 50% relative humidity.

Two 15 mm wide strips of the above described coated polypropylene films were sealed face to face at sealing temperatures ranging from 90 till 120° C. (Low pressure lab sealer from Brugger, sealing pressure is 0.035 bar, dwell time is 0.2 sec). In each case the seal strength was determined using tensile test equipment (Lloyd Instruments) at a speed of 150 mm/min. The maximum tensile force is taken as the seal strength.

TABLE 8
Application data of additional example V - peel force N/15 mm

| Entry | a | b | c |
|---|---|---|---|
| SS (90) | 0.1 | 0.2 | 1.1 |
| SS (100) | 0.2 | 0.9 | 1.7 |
| SS (110) | 0.2 | 1.6 | 2.1 |
| SS (120) | 0.2 | 1.8 | 2.3 |

Note:
SS(x) is the seal strength at the indicated sealing temperature x (in N/15 mm)

In case of sample a (without ADH, without primer) the failure mode is at the coating/BOPP interface, while cohesion failure is observed for samples b and c (including primer).

The results of samples b and c show that especially at low sealing temperatures the seal strength is higher for the ADH containing sample. This clearly indicates that the ADH not only provides proper adhesion between the coating and the corona treated BOPP film (as shown in examples I-IV, but also provides cohesion/seal strength.

### Example VI

Acrylic coated BOPP films are normally not sealed immediately after the coating process and therefore the coating properties must be stable over time (the so-called shelf life).

The following systems were compared in a lab experiment (table 9):

### Entry a of Table 9:

The acrylic binder #1 (example II) with ADH and ammonia (base), coated on the corona treated BOPP surface.

### Entry b of Table 9:

The acrylic binder #1 (example II) with ADH and in which the ammonia (base) is replaced by 75 g NaOH (base, 0.33 weight % in H₂O), coated on the corona treated BOPP surface.

### Entry c of Table 9:

The acrylic binder #1 (example II) with ADH, NaOH (base, same as in Entry b of table 9) and 5 weight % Sorbitol (humectant, 70 weight % in H₂O), coated on the corona treated BOPP surface.

### Preparation and Application of an Aqueous Sealing Coating:

The coating dispersions are applied as received on fresh corona treated oriented polypropylene MB400 from Jindal by using a wire bar coating technique. The coated film is dried in a laboratory oven for 1 minute at a temperature of about 80° C. The dry coating weight is 1.0+/−0.2 g/m².

### Testing of the Coated Film:

Prior to testing, all coated samples were stored at 3 different conditions:
for 1 hr at about 21° C. and 50% relative humidity
for 1 day at about 21° C. and 50% relative humidity
for 1 week at about 21° C. and 50% relative humidity

Two 15 mm wide strips of the above described coated polypropylene films were sealed face to face at sealing temperatures ranging from 90 to 120° C. (Sealing equipment from Brugger, sealing pressure is 1 bar, dwell time is 0.7 sec). In each case the seal strength was determined using tensile test equipment (Lloyd Instruments) at a speed of 150 mm/min. The maximum tensile force is taken as the seal strength.

TABLE 9
Application data of additional example VI - peel force N/15 mm

| | Entry a | | | Entry b | | | Entry c | | |
|---|---|---|---|---|---|---|---|---|---|
| | | | 1 | | | 1 | | | 1 |
| | 1 hr | 1 day | week | 1 hr | 1 day | week | 1 hr | 1 day | week |
| SS (90) | 2.8 | 0.6 | 0.2 | 4.8 | 3.2 | 1.7 | 1.9 | 3.8 | 2.9 |
| SS | 3.4 | 2.4 | 0.3 | 4.7 | 4.6 | 2.8 | 2.0 | 4.2 | 3.6 |
| (100) | | | | | | | | | |
| SS | 4.7 | 3.6 | 0.6 | 5.0 | 5.0 | 3.3 | 2.1 | 4.1 | 4.2 |
| (110) | | | | | | | | | |
| SS | 4.9 | 4.7 | 0.8 | 5.0 | 5.0 | 3.6 | 2.9 | 4.3 | 4.5 |
| (120) | | | | | | | | | |

Note:
SS (x) is the seal strength at the indicated sealing temperature x (in N/15 mm)

The results of samples b and c show that the shelf life of the coated BOPP film is increased by the the use of NaOH as base (instead of ammonia) and that the shelf life is even more improved by the addition of a humectant (combined with NaOH as base).

1. A binder composition for heat-sealable film coatings, the binder composition comprising:
(a.) from 10 to 65 weight-% of a polymeric binder,
said polymeric binder containing as monomers
(i.) keto- or aldehyde containing monomers,
(ii.) monoolefinically unsaturated monomers, and
(iii.) copolymerizable surfactants,
wherein said monoolefinically unsaturated monomers (ii.) contain less than 0.4 weight-% of said monomers with acidic functional groups or amides of acidic functional groups with respect to a total weight of said monomers (i.)-(iii.),
(b.) from 2.5 to 100 mole-% dihydrazide crosslinker with respect to keto- or aldehyde-containing monomers (i.),
(c.) from 0 to 3.0 weight-% non-reactive surfactant,
(d.) from 35 to 90 weight-% water,
(e.) from 0 to 20 weight-% other additives, and
(f) from 0 to 20 weight-% humectant,
wherein a total amount of said components (a.)-(f.) is equal to 100 weight-% of the binder composition.

2. The binder composition according to claim 1, wherein said polymeric binder (a.) comprises
(i.) from 1 to 15 weight-% keto- or aldehyde-containing monomer,
(ii.) from 70 to 98 weight-% monoolefinically unsaturated monomers, and
(iii.) from 0.5 to 15 weight-% copolymerizable reactive surfactant, wherein the total amount of components (i.), (ii.), and (iii.) is equal to 100 weight-% of said polymeric binder (a.).

3. The binder composition according to claim 1 wherein said polymeric binder (a.) contains as monoolefinically unsaturated monomers (ii.) alkyl acrylates, alkyl methacrylates, hydroxy-, epoxy- or anhydride-containing monoolefinically unsaturated monomers, vinyl esters, vinyl chloride, styrenes, acrylic acid, methacrylic acid, itaconic acid, acrylamide or methacrylamide.

4. The binder composition according to claim 1 wherein said polymeric binder (a.) has a weight average molecular weight (Mw) of at least 20.000 g/mol.

5. The binder composition according to claim 1 wherein said polymeric binder (a.) has a number average molecular weight (Mn) of at least 5.000 g/mol.

6. The binder composition according to claim 1 wherein said polymeric binder (a.) has a polydispersity index (PDI) (Mw/Mn) of from 2 to 40.

7. The binder composition according to claim 1 wherein said polymeric binder (a.) has a glass transition temperature (Tg) of from −5 to 75° C.

8. The binder composition according to claim 1 wherein said non-reactive surfactant (c.) is selected from polyethoxylated linear primary fatty alcohols, polyethoxylated branched primary fatty alcohols, polyethoxylated linear secondary fatty alcohols or polyethoxylated branched secondary fatty alcohols.

9. The binder composition according to claim 1 wherein said other additives (e.) are selected from one or more of defoamers, wetting agents, waxes, mineral fillers, and polymeric fillers.

10. A process for preparing an aqueous sealing coating, the process comprising applying a binder composition according to claim 1 on a heat-sealable film comprising corona treated polyolefins.

11. The process according to claim 10, wherein the heat-sealable film consists of the corona treated polyolefins.

12. The process according to claim 10, wherein the polyolefins are polyethylene and polypropylene.

13. An aqueous sealing coating obtained by a process according to claim 10.

14. A process of using the binder composition in accordance with claim 1 for preparation of heat-sealable film coatings.

15. A heat-sealable film in contact with an aqueous sealing coating prepared by a process according to claim 10.
